(19) United States
(12) Patent Application Publication
(10) Pub. No.: US 2006/0187020 A1
(43) Pub. Date: Aug. 24, 2006

(54) Personal message device

(76) Inventors: Denise Smithkovec-Chilton, Bedford Heights, OH (US); Daniel Howe, Cleveland Heights, OH (US); Frank Merat, University Heights, OH (US)

Correspondence Address: Brouse McDowell;Suite 500, 388 South Main Street, Akron, OH, 44311-4407, US

(21) Appl. No.: 11/360,834

(22) Filed: Feb. 23, 2006

Related U.S. Application Data
(60) Provisional application No. 60/655,523, filed on Feb. 23, 2005.

(51) Int. Cl. G08B 1/00

(52) U.S. Cl. 340/531

(57) ABSTRACT

A message device to be installed at a location for storing a message left by a visitor for an intended recipient while the intended recipient is absent from the location. The message device includes a housing to be installed externally of the location where it can be accessed by visitors to the location. The housing includes a substantially-planar writing surface upon which a paper can be placed while the visitor writes the message to be left for the intended recipient on the paper, an aperture in which the paper can be inserted once the visitor has completed the message, and a cavity for receiving the paper inserted into the aperture and storing the paper until the paper is later retrieved by the intended recipient. A writing utensil is provided to be retrievable by the visitor when the visitor is located adjacent to the housing for writing the message on the paper.

### CROSS-REFERENCE TO RELATED APPLICATIONS

This application claims the benefit of U.S. Provisional Application No. 60/655,523, filed on 23 Feb. 2005.

### BACKGROUND OF THE INVENTION

1. Field of the Invention

The present invention is directed generally to a device method for leaving a personal message for one or more people, and more specifically to a personal message device allowing a visitor to leave a message at a primary location from where it can later be retrieved by the intended recipient.

2. Description of Related Art

It is known in the art to install answering machines in conjunction with a telephone for use in storing and retrieving messages in the event that a person is unable to answer the phone. Typically, the answering machine includes a port in which a cable can be inserted to connect the answering machine to the telephone line. A missed call is automatically answered by the answering machine and a pre-recorded voice instruction message is played to inform the caller that the intended recipient is not available, and that the caller can leave a message. Such a technology offers the intended recipient the convenience of recording telephone messages that would otherwise be undeliverable, however, the telephone answering machine offers no such convenience if the caller appears in person at the intended recipient's residence instead of calling.

Mailboxes have traditionally been the receptacle of choice for leaving personal messages at the residence of an occupant when a visitor arrives to find that the occupant is not home. The visitor must come equipped with a writing utensil and a piece of paper on which the visitor can write a personal message to the occupant. Once these instruments are located, the visitor can place the paper on a rigid surface such as the ground, a car or the top of the mailbox to write the desired message and then place the message into the interior of the mailbox.

Although mailboxes can temporarily store personal messages for the occupant of the residence until the occupant returns, mailboxes are commonly found adjacent to the street on which the residence is located, requiring the occupant to make a special trip to the mailbox to retrieve any messages left therein. Further, since mail is routinely delivered according to a predetermined schedule, the occupant of the residence will often not check the mailbox at times other than the typical delivery time of the local postal service. And to permit delivery of the mail by the postal service, mailboxes lack security measures that render them freely accessible by the general public.

Accordingly, there is a need in the art for a personal message device for storing personal messages left at a primary location such as a residence when an occupant of the residence is unavailable. The personal message device can optionally include one or more of a physical cavity in which personal messages written on paper can be deposited, a memory for recording vocal personal messages left by a visitor, and a security measure for limiting access to any personal messages left by a visitor. Alternately, the personal message device is to be located at any alternate location other than a residence, such as an office, for storing messages left by visitors when the intended recipient of the messages is absent from the alternate location.

### BRIEF SUMMARY OF THE INVENTION

According to one aspect, the present invention provides a message device to be installed at a location for storing a message left by a visitor for an intended recipient while the intended recipient is absent from the location. The message device comprises a housing to be installed externally of the location where it can be accessed by visitors to the location. The housing comprises a substantially-planar writing surface upon which a paper can be placed while the visitor writes the message to be left for the intended recipient on the paper, an aperture in which the paper can be inserted once the visitor has completed the message, and a cavity for receiving the paper inserted into the aperture and storing the paper until the paper is later retrieved by the intended recipient. A writing utensil is provided to be retrievable by the visitor when the visitor is located adjacent to the housing for writing the message on the paper.

According to another aspect, the present invention provides a message device to be installed externally of a location to which an intended recipient of a message will return for storing the message left by a visitor for the intended recipient while the intended recipient is absent from the location. The message device comprises an actuator for indicating the presence of the visitor at the location; a message-input device presented to the visitor when the visitor approaches the message device, wherein the message-input device is to be utilized by the visitor for entering the message to be left for the intended recipient; and a computer-accessible memory for storing the message input by the visitor with the message-input device.

According to another aspect, the present invention provides a message device to be installed at a location for storing a message left by a visitor for an intended recipient while the intended recipient is absent from the location. The message device comprises visitor-interface means for creating the message from the visitor to be left for the intended recipient, message-storage means for storing the message left by the visitor for the intended recipient, message-retrieval means for retrieving the message left by the visitor and presenting the message to the intended recipient, and security means for limiting access to the message in the message-storage means to the intended recipient and any other authorized individuals.

### BRIEF DESCRIPTION OF THE DRAWINGS

FIG. 1 is a perspective view of a message device installed adjacent to an entrance to a residence;

FIG. 2 is a perspective view of an embodiment of a message device adjusted to a stowed position;

FIG. 3 is a perspective view of an embodiment of a message device adjusted to an extended position;

FIG. 4 is a perspective view of an embodiment of a message device adjusted to a stowed position;

FIG. 5 is a perspective view of an embodiment of a message device adjusted to an extended position;

FIG. 6 is a cross-sectional view of the housing of an embodiment of a message device;

FIG. 7 is a flow diagram illustrating a method of controlling a message device according to an embodiment of the present invention; and

FIG. 8 is a front view of an electronic message device according to an embodiment of the present invention.

### DETAILED DESCRIPTION OF ILLUSTRATIVE EMBODIMENTS

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

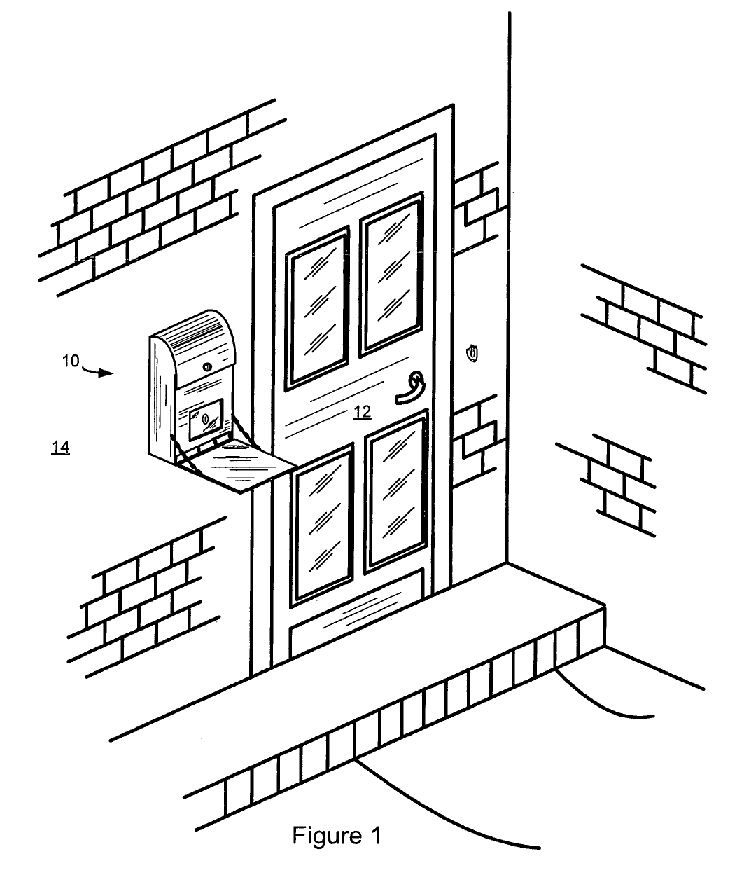

FIG. 1 illustrates a message device 10 according to an embodiment of the present invention to be installed at a location for storing a message left by a visitor for an intended recipient while the intended recipient is absent from that location. As shown in FIG. 1, the message device is installed adjacent to an external side of a door 12 leading into the intended recipient's residence 14, however, the present invention is not limited to residential installations. Instead, the message device 10 can be installed externally of any location where the intended recipient is expected to arrive or return to retrieve the message, such as a corporate office, university office, classroom, recreational facility, or any other location.

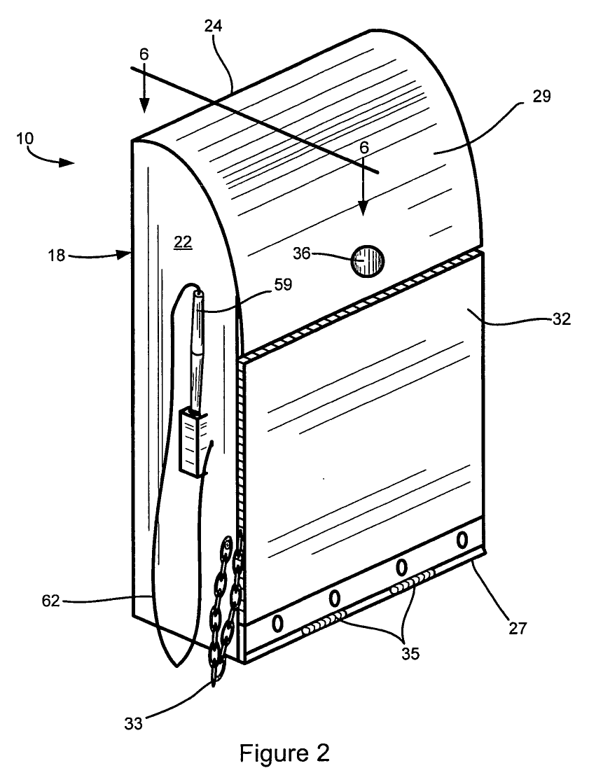

An embodiment of the message device 10 is shown in FIG. 2, and includes a generally-rigid housing 18 to be installed externally of the location where it can be accessed by visitors to the location. The housing 18 of FIG. 2 includes side walls 22, a top 24 and a bottom 27 to form an enclosed structure. A lid 29 can be pivotally coupled by one or more hinges (not shown) to the housing 18 to conceal a stock of paper and an aperture leading into an interior cavity of the housing 18, both of which are discussed in detail below. The generally-rigid material of which the housing is constructed can be selected as any generally-rigid material that can withstand environmental conditions in the location that the message device 10 is to be used. For instance, if the message device 10 is to be located externally of a residence, then the material is to withstand environmental elements such as rain, snow, sunlight, and the like. Examples of suitable materials include wood, plastic and plastic composites, metal and metal alloys, and combinations thereof.

The housing 18 of this embodiment includes a substantially-planar writing surface 32 upon which a sheet of paper (not shown) can be placed while the visitor writes the message to be left for the intended recipient thereon. By substantially planar, it is meant that the writing surface 32 need not be perfectly planar, but it can permissibly be slightly arcuate or otherwise non-planar to a degree that still permits the visitor to write the message on the paper with the paper placed on the writing surface 32. As shown in the Figures, however, the writing surface 32 appears to be planar.

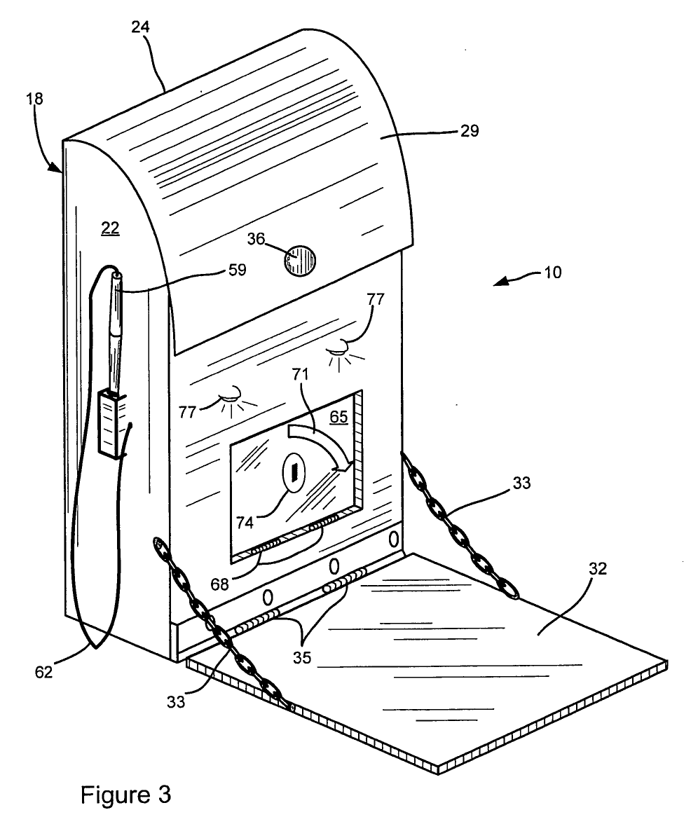

The writing surface 32 can optionally be adjustably coupled to the housing 18 so that the writing surface 32 can be adjusted between a stowed position as shown in FIG. 2 and an extended position as shown in FIG. 3. A writing-surface support, such as a chain 33 extending between a side 22 of the housing 18 and the writing surface 32 in the extended position can optionally be provided to stabilize the writing surface 32 while a visitor writes thereon. An embodiment of an adjustably-coupled writing surface 32 includes the writing surface 32 being pivotally coupled to the housing 18 with one or more hinges 35. A hinge is a well-known pivotal fastener that includes two flanges, each one to be coupled to one of the components to be pivotally coupled together. Each flange includes a passage defined by a plurality of loops extending from an inward portion of the flange. The passages defined by the loops extending from each flange are aligned, and a pin is extended through the commonly-aligned passages to couple the flanges together while allowing rotation of the flanges relative to each other. The hinge is but one way to pivotally couple the writing surface 32 to the housing 18, and any other suitable device for establishing the pivotal relationship of these two features can also be used within the scope of the present invention.

A latch (not shown) can optionally be provided to maintain the writing surface 32 in the stowed position when not in use. An adjustable handle 36 is operable to release the latch and allow the writing surface 32 to be adjusted from the stowed position to the extended position. The handle 36 can also be grasped to pivotally open the lid 29 and reveal the slot 47 leading to the interior cavity 49 of the housing 18.

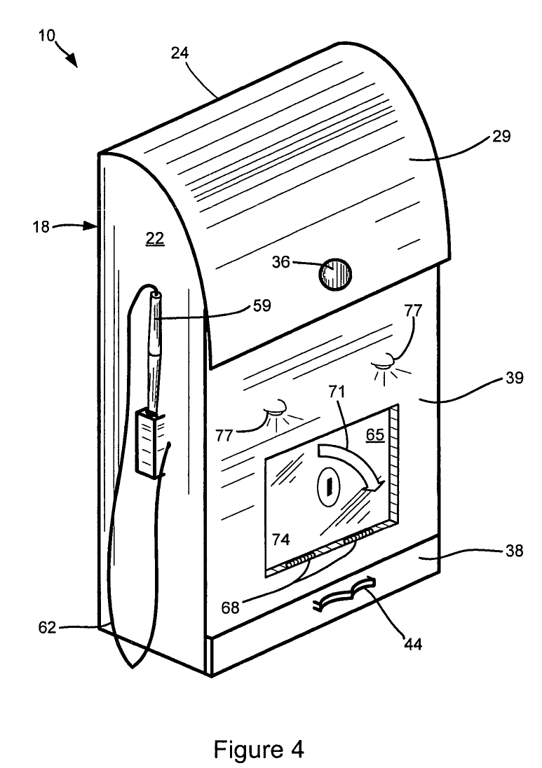

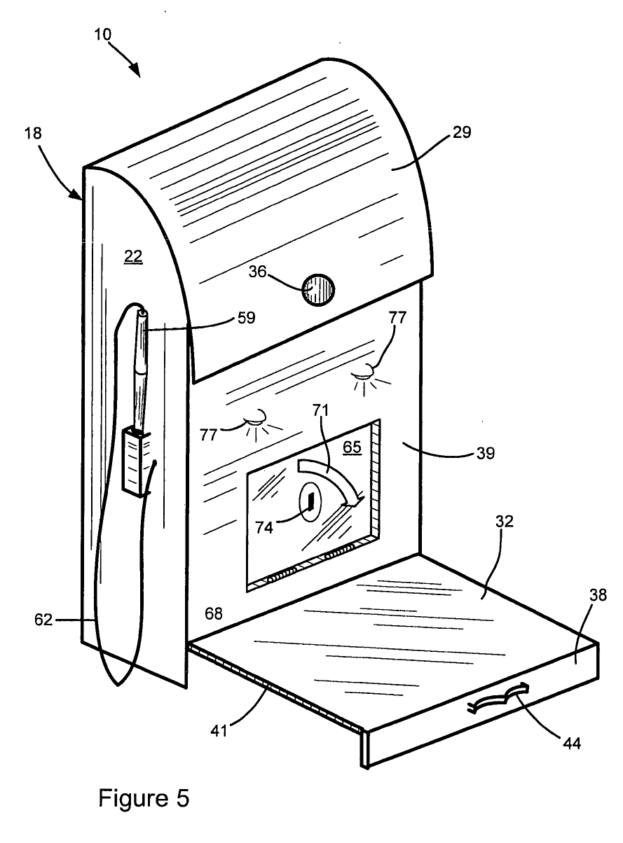

According to an alternate embodiment, the adjustable coupling of the writing surface 32 to the housing 18 can be established through a drawer-type arrangement as shown in FIGS. 4 and 5. In FIG. 4, an exposed surface 38 of the writing surface 32 appears substantially flush with the front 39 of the housing 18 when the writing surface 32 is in the stowed position. The writing surface 32 is provided with a pair of rails 41, shown in FIG. 5, with one rail 41 provided to each lateral side of the writing surface 32. Each rail 41 rests on compatible track (not shown) formed within the interior of the housing 18 and can be slid along that track between a stowed and an extended position. A handle 44 secured to the exposed surface 38 can be grasped and pulled to extract the writing surface 32 from within the housing 18 to reposition the writing surface from the stowed position in FIG. 4 to the extended position shown in FIG. 5, and vice versa. Bearings, wheeled tracks, and other such adjustable joints can optionally be installed to facilitate insertion and removal of the writing surface 32 into and out of the housing 18.

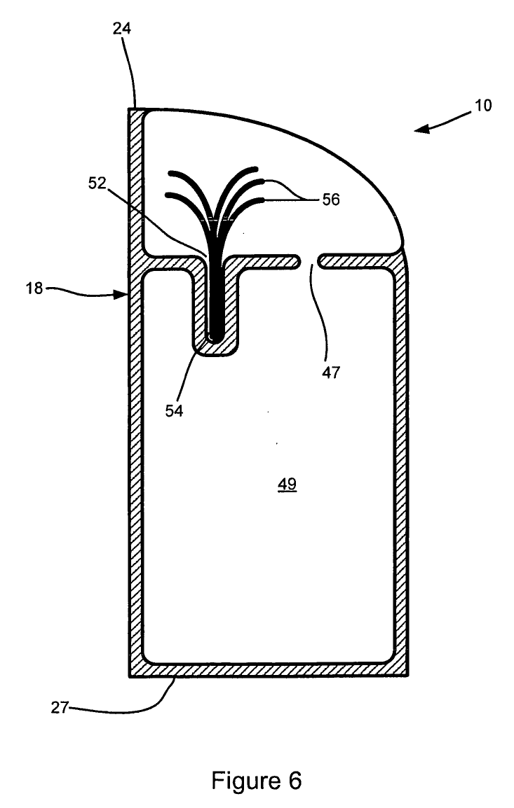

Page 7 of 25 slot 47 or other type of aperture that may be formed in the housing 18 for insertion of the message written on a piece of paper into an interior cavity 49 of the housing 18. The embodiments shown in FIGS. 2-5 have the slot 47 formed adjacent to the top 24 of the housing 18 to allow the piece of paper with the message to be inserted by the visitor into the interior cavity 49. The slot 47 can have any shape and size so long as it permits the insertion of paper therethrough en route to the interior cavity 49, as shown in FIG. 6. A second slot 52 can optionally be integrated into the top 11 of the housing 18 leading to a pocket 54 for holding paper 56 or other writing substrates on which a visitor can write a message to the intended recipient. The lid 29 conceals the slots 47, 52 while in a closed position as shown in the Figures. The lid 29 can be pivotally adjusted to an open position to reveal the slots 47, 52, thereby allowing the visitor to place the paper with the desired message into the interior cavity 49 of the housing 18.

Referring back to FIGS. 2 and 3, a writing utensil 59 can optionally be provided to the housing 18 to be used by the visitor to write the message on the paper 56 that will be left in the interior cavity 49 for the intended recipient. The writing utensil 59 can be a pen, pencil, marker, or any other writing instrument that can write on the paper 56 or other writing substrate stored in the pocket 54 of the housing 18 for use by visitors. A chain, rope or any tether 62 can secure the writing utensil 59 to the housing 18 while still permitting visitors to use the writing utensil 59 to write their messages to the intended recipient.

Once the visitor is finished writing the message on the paper 56, the paper 56 can be deposited through the slot 47 and into the interior cavity 49, from where the paper 56 can later be retrieved by the intended recipient. A door 65 can be exposed to the exterior of the housing 18 to permit limited access to the cavity 49 where messages can be left. The door 65 can be pivotally coupled to the housing 18 with one or more hinges 68, thereby allowing the door 65 to pivot between a closed position and an open position in the direction along arrow 71.

A security measure 74 can optionally be provided to limit access to the paper 56 while it is in the cavity 49. As shown in FIGS. 2 and 3, the security measure 74 is a lock that requires a key to unlock the door 65 before it can be opened. Alternate embodiments optionally include a security measure 74 that require a password to be entered, or a voice command to be issued to unlock the door 65 before it can be opened.

The message device 10 can optionally be integrally installed within the door 12 of the intended recipient's residence or otherwise installed to permit access to messages placed in the cavity 49 from within the intended recipient's residence. According to such embodiments, a secondary door (not shown) of the housing 18 can be reached through the door 12 or other structural member of the residence, allowing the intended recipient to retrieve messages from the cavity 49 without leaving the residence.

To enhance the ability of the visitor to write a message in a low-light environment, a light 77 can optionally be provided to illuminate the writing surface 32 in a substantially-horizontal orientation, such as when the writing surface 32 is in the extended position. The light 77 can be any type of light that can emit sufficient light energy to illuminate the message being written on the paper 56 upon the writing surface 32. Examples of suitable lights include, but are not limited to a light-emitting diode, an organic light-emitting diode, an incandescent light, and a florescent light.

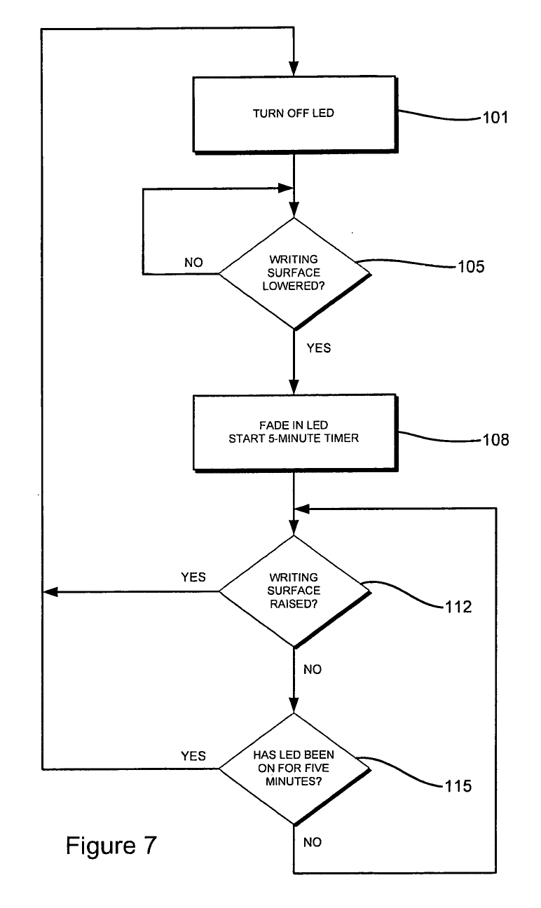

Control of the light 77 can optionally be manual or automatic. For manual operation, the visitor can select whether the light 77 is activated or deactivated with a conventional switch (not shown), such as a toggle switch. Alternately, activation of the light 77 can be based on the position of the writing surface 32 according to a control routine such as that illustrated in FIG. 7. Computer-executable instructions embedded within a microprocessor, for example, can carry out the operations necessary to effectuate the various steps of the routine in FIG. 7. An example of a suitable microprocessor is the PIC16F630A manufactured by Microchip Technologies, Inc. However, the present invention also encompasses other control mechanisms such as mechanical switches and contacts that can be opened or closed depending on the position of the writing surface 32.

The control routine in FIG. 7 takes the form of an endless loop that is repeatedly performed without interruption once the routine has begun. At step 101, the light 77, which in this case is a light-emitting diode (“LED”), is initially deactivated. Step 105 is the initial conditional statement where it is determined if the writing surface 32 is adjusted to the extended position as shown in FIGS. 3 and 5, or to the stowed position as shown in FIGS. 2 and 4. If it is determined at step 105 that the writing surface 32 has been adjusted to the extended position, then the LED is activated, which can include a gradual increase in the emitted light energy until the LED reaches its maximum brightness. If, at step 105 it is determined that the writing surface 32 is in the stowed position, the control routine repeats step 105. This continues until the control routine determines that the writing surface 32 has been adjusted to the extended position.

With the writing surface 32 adjusted to the extended position, the LED is activated and a timer (not shown) is started at step 108 to determine whether a predetermined period of time has elapsed. For the routine illustrated in FIG. 7, the predetermined period of time is set to five (5) minutes. The timer can be an external clock, or it can be based on an internal oscillator of the microprocessor. The LED will remain active to illuminate the writing surface 32 until it is determined at step 115 that the predetermined period of time has elapsed, unless it is determined before that time at step 112 that the writing surface 32 has been returned to the stowed position. The LED is deactivated upon the first of those conditions to occur. When the LED is deactivated, the routine starts over and continues as described above.

The message device 10 can also optionally include an indicator that indicates the presence of a message left by a visitor for the intended recipient. For example, the visitor can manually raise a flag or other visually-identifiable sign that notifies the intended recipient that a message is available within the cavity 49 to be retrieved.

Although the embodiments described above make specific reference to the location of various features, such as the slot 47, the second slot 52, and the location of the writing surface 32, the present invention is not limited to these specifically-disclosed locations. For example, the slot 47 can be formed in a front surface or either side wall 22 of the housing 18. Such alterations are considered to be within the scope of the claims appended hereto.

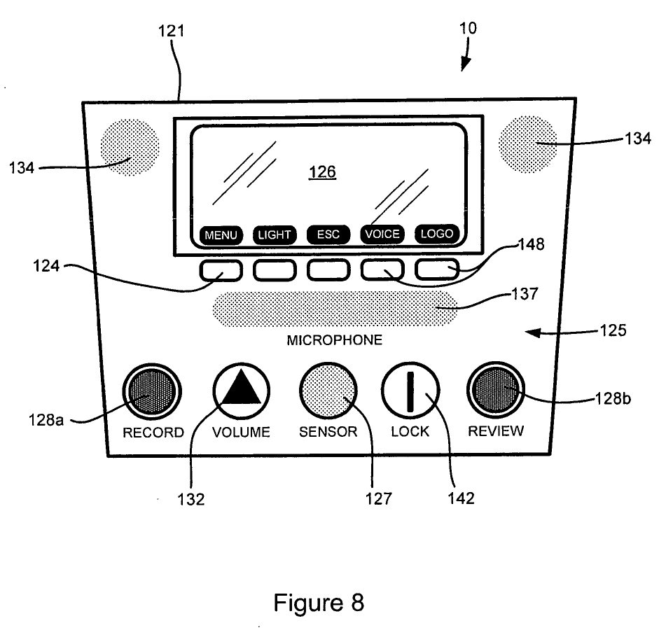

Alternate embodiments of the message device 10 according to the present invention are best understood with reference to FIG. 8. The message device 10 according to these embodiments includes electronic circuitry disposed within a dielectric housing 121 for use in facilitating electronic storage and retrieval of an audible message left by a visitor. In response to the detection of a visitor's presence adjacent to the message device 10, the visitor is presented with the option of leaving a verbal message for the intended recipient, a message that can later be received in an audible format by the intended recipient.

According to the embodiment of the message device 10 shown in FIG. 8, the presence of the visitor can be detected by a manually-operable actuator 124 operated by the visitor, a motion sensor 127, an electronic circuit in communication with a doorbell (not shown), any other device that can detect a quantity indicative of the presence of a visitor adjacent to the message device 10, or any combination thereof. For the message device 10 provided with multiple devices for detecting the presence of a visitor, any one or more can be selected as being the active sensor(s) to control operation of the message device 10, while the others can optionally be deactivated.

A central processing unit (“CPU”) (not shown) including a microcontroller with computer-executable instructions commonly referred to as firmware embedded within a memory module, for example, is in electronic communication with the visitor detection devices provided to the message device 10. The microcontroller can respond to the presence of a visitor as detected by the one or more visitor detection devices, and initiate the recording process for recording the verbal message to be left for the intended recipient. Just as before, an example of a suitable microcontroller is the PIC16F630A manufactured by Microchip Technologies, Inc, along with various other Microchip Technologies, Inc. microcontrollers in the 10, 12, 14, 16, 17, 18 and 24 product families. These microcontrollers, including the PIC16F630A can be programmed and reprogrammed as desired to perform the desired operations, thereby making them versatile and adaptable for specific applications.

The electronic circuitry can be contained in a housing 121 made from a dielectric material and mounted to a door 12, wall or other structure from where it can be accessed by a visitor. A user interface 125, which includes at least one of a display screen 126, one or more buttons 128, and a volume control 132, allows the visitor to interact with the message device 10. An on-board power supply (not shown) may be included within the housing 121 to provide power to the electronic circuitry disposed therein. In one embodiment, the power supply may be one or more batteries. The batteries may be common 1.5 Volt AAA batteries for convenience purposes. However, any type of battery may be used with the present invention. Specifically, the message device may utilize two (2) AAA batteries that are contained within the housing that may provide substantially six (6) months of stand-by life. In this manner, the batteries supply cordless power to the message device 10. It is contemplated in an alternate embodiment that the message device may utilize standard AC power, as from an electrical outlet. Still, any means of supplying power to the present invention may be chosen with sound engineering. It is noted here that the device may include low-power shut down features, such that when the device is in playback mode, the speaker amplifier is shut down to conserve power. And similar to the previous embodiments, the message device 10 may be placed at any location where the intended recipient desires to receive messages in their absence.

For the embodiment shown in FIG. 8, two buttons 128a, 128b are provided in electrical communication with the electric circuitry of the message device 10. More specifically, the buttons 128a, 128b communicate directly with the CPU to initiate the recording procedure and to rewind the message recorded to be played back to the visitor before the message is saved, respectively. Pressing the record button 128a transmits a signal to be received by the CPU to signal the initiation of the recording procedure. The receipt of said signal transmitted as a result of pressing the record button 128a causes execution of computer-executable instructions embedded within the microcontroller to audibly play an instructional message for the visitor with a speaker 134 provided to the message device 10. Analogous to the message played by a telephone answering machine, the instructional message informs the visitor of the intended recipient's unavailability, and instructs the visitor to begin reciting the message for the intended recipient following a start signal, such as a beep emitted from the speaker 134.

Following the start signal, the visitor can recite the verbal message to be left for the intended recipient into a microphone 137 of the message device 10 and arranged to pick up the voice of the visitor while the visitor is positioned adjacent to the message device 10. The microphone can be any device capable of converting sound waves into electrical energy such as current and/or voltage, for example that can be modulated by the CPU and used to store the verbal message represented by the sound waves in the memory module. The memory module (not shown) can be the embedded memory of the CPU, or a separate memory such as an EEPROM, SEEPROM, RAM, ROM, hard drive, tape and the like.

Likewise, pressing the playback button 128b transmits a signal to be received by the CPU, the receipt of which causes execution of computer-executable instructions embedded within the microcontroller to play the message recorded by the visitor immediately before the playback button 128b was pressed. The location of the start of the message in the memory module is first located, and then the message is broadcast to be heard by the visitor with the speaker 134. Following playback of the message, the visitor is presented with the option to save the message for the intended recipient or discard the message and recite another one in its place. If the visitor is satisfied with the message and wishes to leave the message for the intended recipient, the visitor can press the playback button 128b once again, and the message will be saved in the memory module. On the other hand, if the visitor is dissatisfied with the message, the visitor can press the record button 128a, and the previously recorded message is discarded, an instructional message may be played for the visitor, and the recording process begins to record the new message.

When the recording process is started by the CPU, after the record button 128a is initially pressed and when a previous message is being replaced, a period of silence for a predetermined period of time following the instructional message played for the visitor can optionally result in a termination of the recording process. A watchdog timer, any internal timer of the microcontroller, or any other timer can be implemented to measure a period of time that has elapsed since the most-recent sound waves have been converted into electric energy by the microphone 137. If the visitor remains silent for the predetermined period of time following the instructional message, the timer will expire and transmit a timeout signal indicating said period of silence to be received by the CPU. Upon receiving the timeout signal, the CPU can optionally play an instructional message to: warn the visitor of the impending termination of the recording process, instruct the visitor to recite the message to be left for the intended recipient, instruct the visitor to speak louder, provide any other instruction or warning to the visitor. Following any such instructional message, the timer can be reset to the timeout-signal period of time, or another time period during which the message device 10 will await for an audible sound from the visitor. If, after waiting for this second period of time, if there is still no response from the visitor, it is assumed that the visitor no longer wishes to leave a verbal message for the intended recipient and the recording process is terminated according to computer-executable instructions executed by the CPU. If, however, the visitor begins to speak at a volume level above a threshold decibel level, the message is to be converted by the microphone 137 and temporarily stored by the CPU as before. Again, the message left by the visitor can be reviewed and the visitor will once again have the option to keep or discard the message. Once the recording process has begun, this continues until the visitor elects to save a message for the intended recipient in the memory module, or an extended period of silence results in termination of the recording process.

As with the previous embodiments discussed above, the message device 10 in FIG. 8 can optionally include a security measure 142 that limits access to messages stored in the memory module. As shown, the security measure 142 includes a lock that requires a key to grant access to play any messages stored in the memory module on the speaker 134. However, just as before, alternate embodiments optionally include a security measure 142 that requires a password to be entered, or a voice command to be issued to grant access to messages stored within the memory of the message device 10.

The message device 10 can optionally include a volume control 132 to control the volume of tones broadcast by the speaker 134. The volume control 132 may be embodied by a potentiometer, which is a three-terminal variable-resistance device for controlling voltages in electric devices. However any device and method of controlling the volume may be incorporated for use with the present invention as chosen with sound engineering judgment.

The optional display screen 126 provided to the message device 10 can display characters to the visitor when the visitor is positioned adjacent to the message device 10. For embodiments that include the display screen 126 but not the verbal-communication components such as the microphone 137 and the speaker 134, instructional messages can be displayed to the visitor by the display screen 126 instead of broadcast by the speaker 134, for example. The display screen 126 can optionally also present to the visitor one or more preprogrammed messages to be left for the intended recipient that are stored in a memory module of the message device 10. The visitor can scroll through the available preprogrammed messages and select one similar to the message that the visitor desires to leave, if such a preprogrammed message exists. Scrolling through available messages and selecting the desired message can be accomplished by the visitor using any type of input device such as a directional button, scroll wheel, soft keys 148 displayed on the display screen, and the like. Soft keys are interface buttons that can have different functions at different times as facilitated by an algorithm stored within the logic-processing unit. The function is displayed by the display screen 126 adjacent to the button currently assigned to bring about execution of that particular function. Likewise, any of the buttons described herein can be soft keys that correspond to a variety of functions.

The display screen 126 may be directly received and affixed onto the circuit board supporting the other electric components of the present invention, and is installed in electric communication with the CPU and other electric devices. It is also noted that the display screen 126 can be any type of display, such as a LCD, OLED, LED plasma, CRT, or any other display device. For example, the display screen 126 can be capable of simultaneously displaying two rows of 16 characters each, while others can display more or less. Additional circuitry known to those of ordinary skill in the art such as a display driver, video memory, and the like, is also provided for proper operation of the display screen 126. Characters to be displayed are selected by the CPU according to computer-readable instructions stored in the memory module, and the characters are formatted to be displayed by the particular display screen 126 chosen.

Other embodiments include a full QWERTY keyboard (not shown) that is presented to the visitor, allowing the visitor to type a desired message to the intended recipient in the event that none of the preprogrammed messages are acceptable to the visitor. The keyboard can be a physical keyboard comprising a plurality of keys that can be pressed to transmit a signal to the CPU, thereby bringing about a predetermined action, or, the keyboard can be displayed as soft keys by the display screen 126.

In use, a visitor may approach the residence or other location where the visitor expects to encounter the intended recipient. Upon arrival, the visitor may realize that the intended recipient is not available or may not be present at that location, and would like to leave a message for the intended recipient. The visitor's presence is detected by the manually-operable actuator 124, motion sensor 127, electronic circuit in communication with a doorbell, etc. . . . , and the message device 10 is awakened from a dormant power-saving state.

An instructional message can be broadcast by the speaker 134, displayed by the display screen 126, otherwise presented to the visitor, or any combination thereof. Alternate embodiments permit the intended recipient to leave a personalized message such as an expected return time, a forwarding address or location, a telephone number, or any other message informing the visitor of the circumstances surrounding the intended recipient's absence. Examples of such personalized messages include: “Gone to Lunch,” “Return in X Minutes,” “Be Right Back,” “Will Return in X Days,” “In the Laboratory,” and the like. The display screen 126 can optionally also display a digital representation of an image, such as a logo. The logo or other image may be customizable as desired by the intended recipient. That is to say that the message device 10 can be selectively programmable to include any image supported by the circuitry of the present invention. In this manner, a company using the present invention may program the message device 10 to display the company's logo. Alternately, an individual user may program the message device 10 with a personalized image. The display may statically depict a single image or may alternatively scroll an image or images and/or message text. The digital image may be displayed at various times during operation of the message device 10. For example, the message device 10 may display the customized image upon being initially turned on. The message device 10 may also display the image after a predetermined time period of inactivity. In fact, any scheme of displaying the customized images may be chosen with sound judgment. In this way, when an approaching visitor activates the message device 10, the display screen 126 may revert from displaying the digital image or logo to the menu selections as mentioned above. In one embodiment, the logo or image is preprogrammed prior to delivery of the message device to the end user. However, it is conceived in an alternate embodiment, that the message device 10 may include a means for downloading image data by the end user.

With knowledge of the instructions for entering a message for the intended recipient, the visitor can record a verbal message via the microphone 137, select from a menu of available preprogrammed messages, or electronically enter the message with the a data-entry device such as a keyboard, soft keys, buttons, or any other data-entry mechanism. Where a verbal message is left for the intended recipient, the visitor is presented with the option of reviewing the message before storing the message in the memory of the message device 10 from where it cannot be retrieved by unauthorized parties. Likewise, the visitor can review a typed or preprogrammed message via the display screen before electing to store the message for the intended recipient in the memory of the message device 10.

Once the visitor is satisfied with the message, the message is stored in the memory of the message device 10, from where it is protected from unauthorized parties by a security measure 142, such as a lock and key, a password, a verbal command or other type of security measure 142. Upon returning to the location where the message device 10 was installed, the intended recipient or other authorized user with the necessary tool to circumvent the security measure 142 can comply with the security measure 142, thereby gaining access to the message(s) stored in the memory of the message device 10. Once such access has been granted, each message can be retrieved and presented to the intended recipient or other authorized user. Presentation of each message can independently be performed audibly by the speaker 134, visually by the display screen 126, or a combination thereof.

According to alternate embodiments, the message device 10 includes a transceiver that facilitates the transmission and reception of electronic data over a communication channel such as a telephone line, cable television line, fiber-optic line, wireless communication channel such as a radio frequency, and the like. In this manner, the message device 10 can communicate with remotely-located terminals such as a desktop computer, server, notebook computer, personal digital assistant (“PDA”), cellular telephone, and the like. According to such embodiments, the intended recipient can bring about transmission of a signal that is to be received by the message device 10 indicating the intended recipient's desire to access messages stored in the memory of the message device 10. Just as before, the intended recipient must enter the appropriate key or other command to circumvent the security-measure limiting access to the memory of the message device 10. Once the appropriate circumvention measure has been entered via the remote terminal, the intended recipient arrives at a menu of available options, including but not limited to, playing the stored messages, erasing the stored messages, and forwarding the stored messages. Such menu options can be selected by pressing an appropriate key of a cellular telephone, for example. The menu option selected by the intended recipient will cause transmission of a signal to the CPU of the message device 10, which, in turn, brings about the appropriate response.

For instance, if the intended recipient desires to listen to an audible message stored in the memory of the message device 10, the CPU can control the retrieval of the electronic data representing the audible message from the memory of the message device 10. The electronic data is broken into packets, which are formatted for transmission by the transmitter portion of the transceiver and then transmitted over the communication channel with which the message device 10 can communicate. The transmitted packets are received by the remote terminal, reassembled and the audible message is played for the intended recipient by a speaker of the remote terminal.

Likewise, text messages stored in the memory of the message device 10 can be transmitted to a remote terminal operated by the intended recipient in an analogous manner. Data is first broken into packets and transmitted as such over a local or wide-area network such as the Internet to the intended recipient's remote terminal, where it is displayed by a display screen such as a monitor.

These are but two illustrative embodiments, and the present invention includes not only packetized data, but also continuous streams of data over dedicated channels, for example. Further, the present invention can transmit data over a wide variety of protocols, such as TCP/IP, CDMA and GMS, among others.

The CPU may also be programmed to perform an auto-shutdown of the device at specific times of the day or days of the week. Still other functions of the device may include serial data transfer of messages and/or information related to the messages, such as date/time stamp. The CPU may include low power features that place any features such as the display screen 126 and speaker 134 in a low-power state. Alternately, the CPU may shut the display screen 126 speaker 134/speaker amplifier down altogether. Again, these actions may be triggered by a watchdog or other timer as chosen with sound engineering judgment.

According to alternate embodiments, the CPU may electrically store message data within a memory such as a voice data array. That is to say that the CPU coordinates the storage of message data via a serial communications bus into the voice data array including a plurality of capacitors. A memory allocation table stored within non-volatile EEPROM memory in the CPU provides such a method to store recorded messages in a manner that allows for complete utilization of the voice data array. This method also allows messages to be erased within the middle of the voice memory array and subsequently re-recorded without disturbing existing messages or loss of message continuity. This method consumes less power than the digital manner of storing data in separate dynamic memory ICs. This minimizes consumption of power from the onboard batteries incorporated to provide to power the message device 10. However, it is noted that any means of storing data electronically may be chosen with sound engineering judgment as is appropriate for use with the present invention.

The embodiments implemented with electric circuitry may include any combination of solid-state devices, discrete electronics, digital and analog devices, and the like. A small form factor circuit board made from silicon, or a silicon composition for example, can be any sized suitable for supporting the needed electric components. An example of one suitably-sized circuit board is a 3-inch by 3-inch single layer circuit board or dual-sided board. However, any size and type of circuit board may be used with the present invention as chosen with sound engineering judgment. The circuit board may also include additional peripheral support circuitry and/or integrated circuits connected to the CPU to facilitate operation of the CPU and the present invention. The CPU and/or peripheral support circuitry may be selectively programmable to perform a preprogrammed series of computer-executable instructions to perform any desired sequence of operation.

Illustrative embodiments have been described, hereinabove. It will be apparent to those skilled in the art that the above devices and methods may incorporate changes and modifications without departing from the general scope of this invention. It is intended to include all such modifications and alterations in so far as they come within the scope of the appended claims.

What is claimed is:

1. A message device to be installed at a location for storing a message left by a visitor for an intended recipient while the intended recipient is absent from the location, the message device comprising:
a housing to be installed externally of the location where it can be accessed by visitors to the location, the housing comprising:
a substantially-planar writing surface upon which a paper can be placed while the visitor writes the message to be left for the intended recipient on the paper,
an aperture in which the paper can be inserted once the visitor has completed the message, and
a cavity for receiving the paper inserted into the aperture and storing the paper until the paper is later retrieved by the intended recipient; and
a writing utensil retrievable by the visitor when located adjacent to the housing for writing the message on the paper.

2. The message device according to claim 1 further comprising a light for illuminating the writing surface.

3. The message device according to claim 2, wherein the light includes at least one of a light-emitting diode, an organic light-emitting diode, an incandescent light, and a florescent light.

4. The message device according to claim 1 further comprising a security measure for limiting access to the paper while it is placed in the cavity.

5. The message device according to claim 4, wherein the security measure comprises:
a door that is adjustably coupled to the housing, wherein the door can be opened to reveal the interior of the cavity and closed to conceal the interior of the cavity; and
a door lock for limiting access to the interior of the cavity.

6. The message device according to claim 1, wherein the door lock can be unlocked with one or more of a key, a password, and a voice command.

7. The message device according to claim 1 further comprising a paper holder for holding a supply of paper on which the message can be written with the writing utensil.

8. The message device according to claim 1, wherein the substantially-planar writing surface extends outwardly away from the housing and is substantially horizontal in an extended position suitable for supporting paper be written upon.

9. The message device according to claim 1, wherein the substantially-planar writing surface is adjustably coupled to the housing and is adjustable between an extended position in which the writing surface is substantially horizontal so the visitor can place the paper thereon when writing the message to the intended recipient, and a stowed position in which extension of the writing surface outwardly from the housing is minimized.

10. The message device according to claim 9, wherein the substantially-planar writing surface is pivotally connected to the housing to rotate between the extended position and the stowed position.

11. The message device according to claim 9, wherein the substantially-planar writing surface is slid-ably coupled to the housing to slide between the extended position and the stowed position.

12. The message device according to claim 9 further comprising a light that is automatically activated to illuminate the writing surface when the writing surface is adjusted to the extended position.

13. The message device according to claim 12, wherein the light is automatically deactivated when the writing surface is adjusted to the stowed position.

14. The message device according to claim 1 further comprising notification means for indicating the presence of a message for the intended recipient within the cavity.

15. A message device to be installed externally of a location to which an intended recipient of a message will return for storing the message left by a visitor for the intended recipient while the intended recipient is absent from the location, the message device comprising:
an actuator for indicating the presence of the visitor at the location;
a message-input device presented to the visitor when the visitor approaches the message device, wherein the message-input device is to be utilized by the visitor for entering the message to be left for the intended recipient; and
a computer-accessible memory for storing the message input by the visitor with the message-input device.

16. The message device according to claim 15, wherein the actuator is in electric communication with a doorbell adjacent to an entrance of a residence of the intended recipient.

17. The message device according to claim 15, wherein the actuator is a button that is to be pressed by the visitor when the visitor desires to leave a message for the intended recipient.

18. The message device according to claim 15, wherein the actuator is a sensor that detects the presence of the visitor adjacent to the message device.

19. The message device according to claim 15, wherein the message-input device is a microphone for receiving an audible message from the visitor to be stored in the computer-accessible memory and later audibly played for the intended recipient.

20. The message device according to claim 15, wherein the message-input device is a keypad comprising a plurality of keys the visitor can press to type the message to be left for the intended recipient.

21. The message device according to claim 20 further comprising a display for displaying the message typed by the visitor for the intended recipient.

22. The message device according to claim 15 further comprising a security measure limiting access to any messages stored in the computer-accessible memory to the intended recipient.

23. The message device according to claim 22, wherein the security measure includes at least one of a password, a voice command, and a key required to retrieve the message from the computer-accessible memory.

24. The message device according to claim 15 further comprising notification means for indicating the presence of a message within the computer-accessible memory.

25. The message device according to claim 15 further comprising a speaker for audibly playing the message from the visitor to the intended recipient.

26. The message device according to claim 15 further comprising a source of stored electric energy for energizing the message device.

27. The message device according to claim 15 further comprising a plurality of predefined messages to be left for the intended recipient from which the visitor can select.

28. A message device to be installed at a location for storing a message left by a visitor for an intended recipient while the intended recipient is absent from the location, the message device comprising:
visitor-interface means for creating the message from the visitor to be left for the intended recipient;
message-storage means for storing the message left by the visitor for the intended recipient;
message-retrieval means for retrieving the message left by the visitor and presenting the message to the intended recipient; and
security means for limiting access to the message in the message-storage means to the intended recipient and any other authorized individuals.

29. The message device according to claim 28 further comprising illumination means for illuminating the visitor-interface means for use in low-light settings.

30. The message device according to claim 28 further comprising message-review means for presenting the message to the visitor before the message is left for the intended recipient.

31. The message device according to claim 30, wherein the message-review means comprises a speaker to audibly play the message to the visitor.

32. The message device according to claim 30, wherein the message-review means comprises a display device for visually presenting the message to the visitor.
